(19) United States
(12) Patent Application Publication
(10) Pub. No.: US 2022/0243745 A1
(43) Pub. Date: Aug. 4, 2022

(54) VALVE DEVICE, PUMP DEVICE AND TRIM TILT DEVICE

(71) Applicant: HITACHI ASTEMO, LTD., Hitachinaka-shi (JP)

(72) Inventor: Koichi HATA, Hitachinaka-shi (JP)

(73) Assignee: HITACHI ASTEMO, LTD., Hitachinaka-shi (JP)

(21) Appl. No.: 17/201,435

(22) Filed: Mar. 15, 2021

(30) Foreign Application Priority Data
Feb. 2, 2021 (JP) 2021-015251

(51) Int. Cl. F15B 15/20; F04B 43/113; F04B 23/02; F15B 1/04

(52) U.S. Cl. CPC F15B 15/20; F15B 1/04; F04B 23/025; F04B 43/113

(57) ABSTRACT

A valve device includes: a flow path forming member having a first flow path through which a fluid is to flow, and a conical second flow path formed on a downstream side of the first flow path and having an outer diameter increasing in a flow direction of the first flow path; a spherical valve body capable of blocking a flow of the fluid in the first flow path by contacting an inner surface of the flow path forming member, which forms the second flow path; a holding member configured to hold the valve body in a conical concave part; and a coil-shaped spring configured to apply a force in a direction of causing the valve body to contact the inner surface via the holding member and arranged so that a direction of a center line of the coil is tilted with respect to the flow direction.

### CROSS-REFERENCE TO RELATED APPLICATION

This application is based upon and claims the benefit of priority to Japanese Patent Application No. 2021-015251, filed on Feb. 2, 2021, the entire contents of which are incorporated herein by reference.

### FIELD OF THE INVENTION

The present invention relates to a valve device, a pump device, and a trim tilt device.

### BACKGROUND OF THE INVENTION

For example, a trim tilt device disclosed in JP-A-2015-183649 includes a cylinder device configured to expand and contract due to supply and discharge of oil, a pump device configured to deliver the oil, a motor configured to drive the pump device, and a tank configured to store the oil. The pump device has a pump case in which a gear pump, and a switching valve, an up-blow valve, a down-blow valve and the like used for a hydraulic circuit are accommodated. The up-blow valve and the down-blow valve each have a ball, a push pin, and a coil spring, and is configured to bring the ball into contact with a member forming a flow path to block a flow path of the oil. The up-blow valve is usually closed, and is opened when a pressure in a pump-side first chamber-side flow path becomes equal to or higher than a predetermined pressure, thereby relieving the oil in the pump-side first chamber-side flow path to a first open flow path leading to the tank. The down-blow valve is usually closed, and is opened when a pressure in a pump-side second chamber-side flow path becomes equal to or higher than the predetermined pressure, thereby relieving the oil in the pump-side second chamber-side flow path to a second open flow path leading to the tank. The case where the pressure in the pump-side first chamber-side flow path becomes equal to or higher than the predetermined pressure includes a case where even after the oil is supplied to a first chamber of the cylinder device and the cylinder device is thus expanded to the maximum of a range of expansion and contraction, the gear pump continues to rotate and the oil is continuously supplied to the first chamber-side flow path, for example. The case where the pressure in the pump-side second chamber-side flow path becomes equal to or higher than the predetermined pressure includes a case where even after the oil is supplied to a second chamber of the cylinder device and the cylinder device is thus contracted to the minimum of the range of expansion and contraction, the gear pump continues to rotate and the oil is continuously supplied to the second chamber-side flow path, for example. In addition, when the pressure in the second chamber-side flow path is increased by an amount of increase in volume of a piston rod advancing into the second chamber upon contraction of the cylinder device, the pressure in the pump-side second chamber-side flow path becomes equal to or higher than the predetermined pressure.

The up-blow valve and the down-blow valve are opened when the pressure in the flow path becomes equal to or higher than a predetermined pressure, so that the oil flows from a slight gap between a slightly opened ball-shaped valve body and an opening of the flow path. When pressure variation occurs, the valve body and the like vibrate, so that a mechanical sound may be generated at a time when the valve body contacts the member forming the flow path. In particular, since the oil of a higher pressure than in the up-blow valve flows in the down-blow valve, the mechanical sound and a whistle sound at a time when the oil flows through the slight gap may be noticeably generated.

An object of the present invention is to provide a valve device and the like capable of suppressing generation of a sound.

### SUMMARY OF THE INVENTION

According to an aspect of the invention, there is provided a valve device comprising: a flow path forming member having a first flow path through which a fluid is to flow, and a conical second flow path formed on a downstream side of the first flow path and having an outer diameter increasing in a flow direction of the first flow path; a spherical valve body capable of blocking a flow of the fluid in the first flow path by contacting an inner surface of the flow path forming member, which forms the second flow path; a holding member configured to hold the valve body in a conical concave part; and a coil-shaped spring configured to apply a force in a direction of causing the valve body to contact the inner surface via the holding member and arranged so that a direction of a center line of the coil is tilted with respect to the flow direction.

According to an aspect of the invention, there is also provided a pump device comprising: a pump configured to supply a fluid; a tank configured to store the fluid; a switching valve configured to switch a flow direction of the fluid supplied from the pump; and the valve device connected to an intermediate flow path between the pump and the switching valve and configured to be opened to return the fluid in the intermediate flow path to the tank when a pressure in the intermediate flow path becomes equal to or higher than a predetermined pressure.

According to an aspect of the invention, there is further provided a trim tilt device comprising: a cylinder device configured to expand and contract due to supply and discharge of a fluid, and the pump device configured to supply the fluid to the cylinder device.

### BRIEF DESCRIPTION OF THE DRAWINGS

FIG. 1 depicts an example of a schematic configuration of a trim tilt device 1 in accordance with a first embodiment.

FIG. 2 is a perspective view depicting an example of a housing 81 and a cylinder 11 of the trim tilt device 1 in accordance with the first embodiment.

FIG. 3 depicts a hydraulic circuit of the trim tilt device 1.

FIG. 4 depicts an example of a sectional view of a down-blow valve 60.

FIG. 5A depicts a spring 64, as seen in a horizontal direction, FIG. 5B depicts the spring 64, as seen in a Vb direction of FIG. 5A, and FIG. 5C depicts the spring 64, as seen in a Vc direction of FIG. 5A.

FIG. 6 depicts an example of a force that is applied to a valve body 61 when a spring 100 of Comparative Example is used.

FIG. 7 depicts an example of a force that is applied to the valve body 61 when the spring 64 of the first embodiment is used.

FIG. 8 depicts an example of a state where oil flows through a gap between the valve body 61 and an inner surface 628 of a valve seat 62.

FIG. 9 depicts an example of a state where a damping force is generated.

FIG. 10 depicts a relation between a pressure generated for the valve body 61 and an amount of displacement of the valve body 61.

FIG. 11 depicts an example of a schematic configuration of a down-blow valve 260 in accordance with a second embodiment.

FIG. 12 depicts an example of a schematic configuration of a down-blow valve 360 in accordance with a third embodiment.

FIG. 13 depicts an example of a schematic configuration of a down-blow valve 460 in accordance with a fourth embodiment.

FIG. 14 depicts a modified example of the fourth embodiment.

FIG. 15 depicts an example of a schematic configuration of a down-blow valve 560 in accordance with a fifth embodiment.

FIG. 16 depicts a modified example of the fifth embodiment.

### DETAILED DESCRIPTION OF THE INVENTION

Hereinbelow, embodiments of the present invention will be described in detail with reference to the accompanying drawings. Note that, the embodiments of the present invention to be described below are just exemplary, and the present invention is not limited to the embodiments.

### First Embodiment

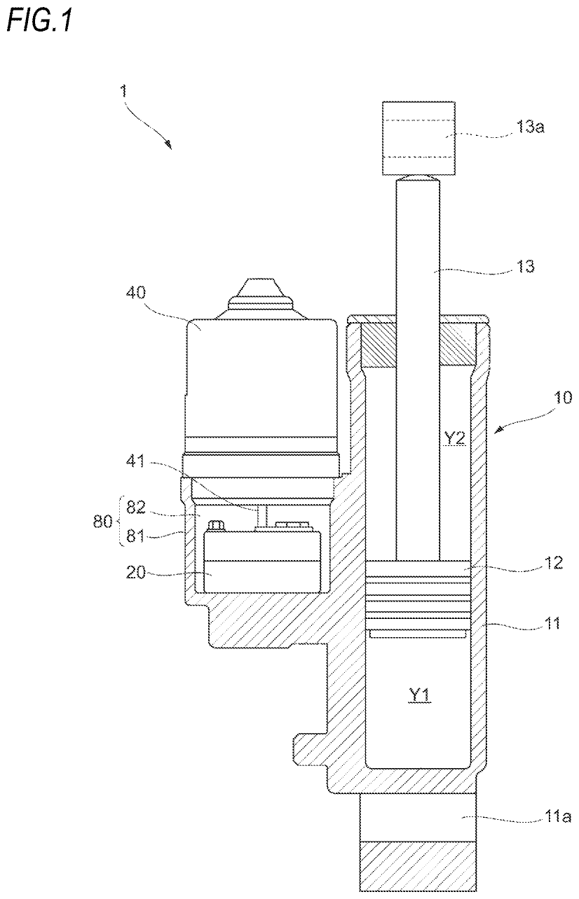

FIG. 1 depicts an example of a schematic configuration of a trim tilt device 1 in accordance with a first embodiment.

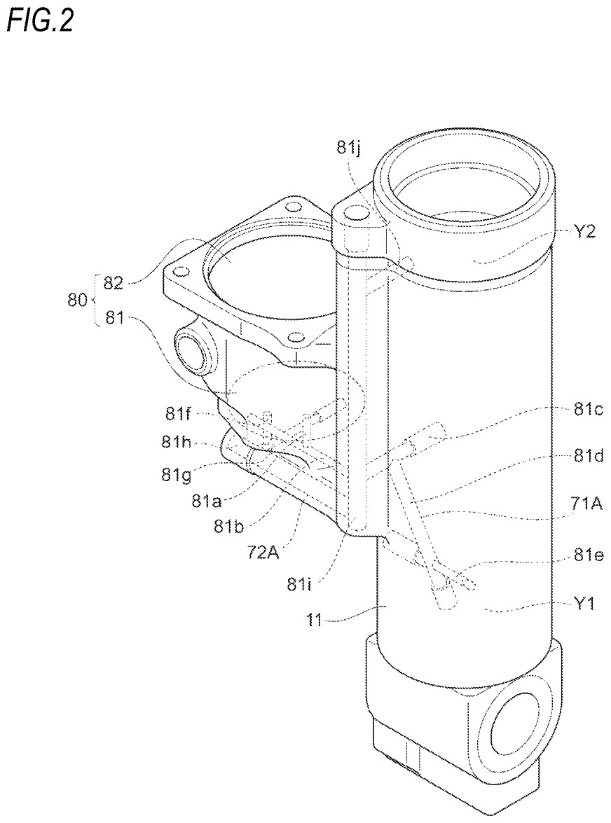

FIG. 2 is a perspective view depicting an example of a housing 81 and a cylinder 11 of the trim tilt device 1 in accordance with the first embodiment.

The trim tilt device 1 of the first embodiment includes a cylinder device 10 configured to expand and contract due to supply and discharge of oil as an example of the fluid, a pump device 20 configured to supply the oil to the cylinder device 10, a motor 40 configured to drive the pump device 20, and a tank 80 configured to store the oil.

The cylinder device 10, the motor 40 and the tank 80 may be the same as the cylinder device 10, the motor 40 and the tank 80 disclosed in JP-A-2015-183649, for example.

The pump device 20 is different from the pump device 20 disclosed in JP-A-2015-183649, in terms of a structure of a down-blow valve 60 corresponding to a down-blow valve 54 of the pump device 20 disclosed in JP-A-2015-183649.

In the below, the trim tilt device 1 of the first embodiment is described. The parts having the same shapes and functions between the trim tilt device 1 of the first embodiment and the trim tilt device 100 disclosed in JP-A-2015-183649 are denoted with the same reference signs, and the detailed descriptions thereof are omitted.

(Cylinder Device 10)

As shown in FIG. 1, the cylinder device 10 has a cylinder 11, a piston 12, and a piston rod 13.

In the cylinder device 10, an inside of the cylinder 11 is demarcated into a first chamber Y1 and a second chamber Y2 by the piston 12. When the oil is supplied to the first chamber Y1, the cylinder device 10 expands, and the oil is supplied to the second chamber Y2, the cylinder device 10 contracts. While the cylinder device 10 expands, the oil is discharged from the second chamber Y2, and while the cylinder device 10 contracts, the oil is discharged from the first chamber Y1.

An end portion of the cylinder 11 is formed with a pin hole lla in which a pin (not shown) for connecting to a stern bracket (not shown) of a ship propulsion machine (not shown) is inserted. On the other hand, an end portion of the piston rod 13 is formed with a pin hole 13a in which a pin (not shown) for connecting to a swivel case (not shown) of the ship propulsion machine (not shown) is inserted.

(Tank 80)

The tank 80 has a housing 81 in which the pump device 20 is accommodated, and a tank chamber 82 that is a space surrounded by the housing 81. The housing 81 may be formed integrally with the cylinder 11, for example. As shown in FIG. 2, the housing 81 and the cylinder 11 are formed with a part of a flow path 71A on the first chamber-side and a part of a flow path 72A on the second chamber-side, as an oil flow path for connecting the pump device 20 and the first chamber Y1 and second chamber Y2 of the cylinder device 10.

A part of the flow path 71A is formed with a first hole 81a, a second hole 81b, a third hole 81c, a hole 81d and a hole 81e of the housing 81 being each connected.

A part of the flow path 72A is formed with a fourth hole 81f, a fifth hole 81g, a sixth hole 81h, a hole 81i and a hole 81j of the housing 81 being each connected.

The pump device 20 is fixed to a bottom part of the tank chamber 82. In the tank chamber 82, the oil is stored, and the pump device 20 is immersed in the oil.

(Motor 40)

As shown in FIG. 1, the motor 40 is fixed to the housing 81 to block an opening of the tank chamber 82. A drive shaft 41 of the motor 40 is coupled to the pump device 20 arranged in the tank chamber 82.

(Hydraulic Circuit of Trim Tilt Device 1)

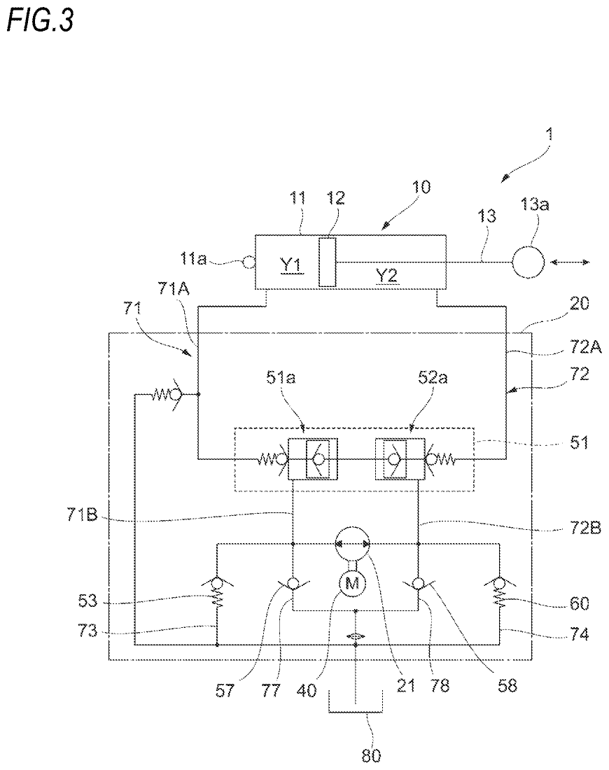

FIG. 3 depicts an example of a hydraulic circuit of the trim tilt device 1.

The hydraulic circuit shown in FIG. 3 is a circuit configured to control supply and discharge of the oil with respect to the first chamber Y1 and the second chamber Y2.

A flow path 71 on the first chamber-side leading to the first chamber Y1 and a flow path 72 on the second chamber-side leading to the second chamber Y2 are formed between a gear pump 21 having a pair of gears and configured to drive to discharge oil by the motor 40 and the cylinder device 10. The flow path 71 and the flow path 72 are provided with a switching valve 51 configured to switch a flow direction of the oil to the first chamber Y1 or the second chamber Y2 over the flow path 71 and the flow path 72. The switching valve 51 has a first open valve Ma provided on the flow path 71 and a second open valve 52a provided on the flow path 72.

(Up-blow Valve 53)

An up-blow valve 53 is connected to a flow path 71B, which leads from the gear pump 21 to the first open valve 51a, of the flow path 71. The up-blow valve 53 is usually closed, and is opened when a pressure in the flow path 71B becomes equal to or higher than a predetermined pressure, thereby relieving the oil in the flow path 71B to a flow path 73 leading to the tank 80.

The case where the pressure in the flow path 71B becomes equal to or higher than the predetermined pressure includes a case where even after the oil is supplied to the first chamber Y1 of the cylinder device 10 and the cylinder device 10 is thus expanded to the maximum of a range of expansion and contraction, the gear pump 21 continues to rotate and the oil is continuously supplied to the flow path 71, for example. In this case, the up-blow valve 53 is opened to return the oil supplied to the flow path 71B to the tank 80 through the flow path 73.

(Down-blow Valve 60)

A down-blow valve 60 is connected to a flow path 72B, which leads from the gear pump 21 to the second open valve 52a, of the flow path 71. The down-blow valve 60 is usually closed, and is opened when a pressure in the flow path 72B becomes equal to or higher than a predetermined pressure, thereby relieving the oil in the flow path 72B to a flow path 74 leading to the tank 80.

The case where the pressure in the flow path 72B becomes equal to or higher than the predetermined pressure includes a case where the pressure in the flow path 72 is increased by an amount of increase in volume of the piston rod 13 advancing into the second chamber Y2 upon contraction of the cylinder device 10, and a case where even after the oil is supplied to the second chamber Y2 of the cylinder device 10 and the cylinder device 10 is thus contracted to the maximum of the range of expansion and contraction, the gear pump 21 continues to rotate and the oil is continuously supplied to the flow path 72, for example. In this case, the down-blow valve 60 is opened to return the oil supplied to the flow path 72B to the tank 80 through the flow path 74.

Note that, while the cylinder device 10 expands and contracts, the oil in the first chamber Y1 and the oil in the second chamber Y2 mostly just circulate via the switching valve 51 and the gear pump 21. However, as described above, a total amount of the oil in the first chamber Y1 and the oil in the second chamber Y2 changes according to an advancing amount of the piston rod 13 into the second chamber Y2. For this reason, when an amount of the oil to be fed to the first chamber Y1 or the second chamber Y2 is insufficient, an amount of oil corresponding to the insufficient amount is supplied from the tank 80 to the gear pump 21 through a first supply flow path 77 or a second supply flow path 78 on each of which check valves 57 and 58 are each provided. Whether the flow path for supplying the oil from the tank 80 to the gear pump 21 is the first supply flow path 77 or the second supply flow path 78 is determined according to a rotation direction of the gear pump 21.

(Structure of Pump Device 20)

The pump device 20 is integrally constituted by accommodating the gear pump 21, the switching valve 51, the up-blow valve 53, the down-blow valve 60, the two check valves 57 and 58 and the like in a pump case 25. In the below, the down-blow valve 60 is described in detail.

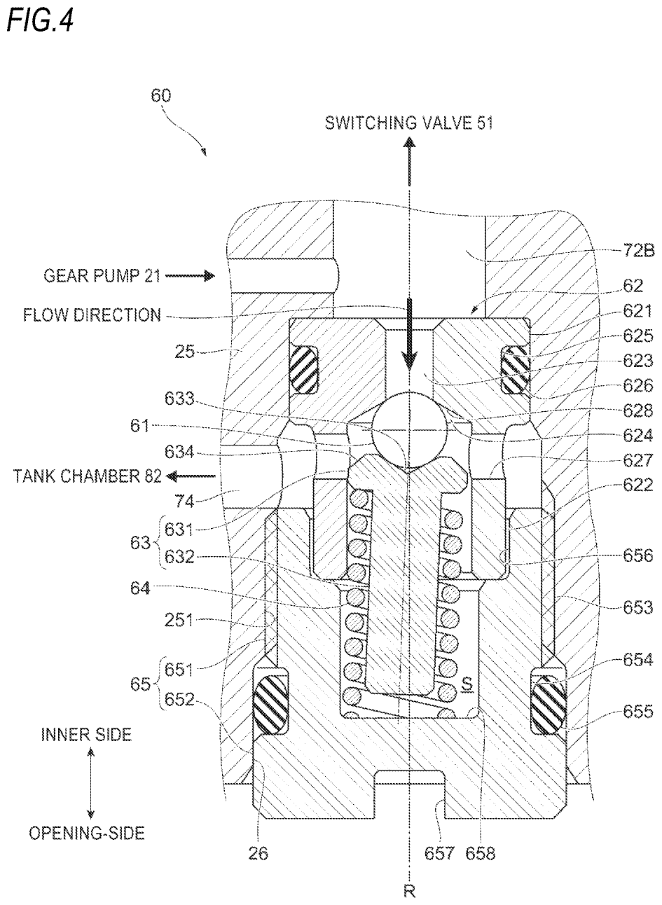

FIG. 4 depicts an example of a sectional view of the down-blow valve 60.

The down-blow valve 60 has a spherical valve body 61, a valve seat 62 on which the valve body 61 is seated, a holding member 63 configured to hold the valve body 61, a spring 64, and a cap 65 configured to block an opening of a hole formed in the pump case 25.

The valve seat 62 is inserted in a concave part 26 formed in the pump case 25 and configured to communicate with the flow path 72B. The valve seat 62 has a columnar part 621 arranged on an inner side of the concave part 26 and a cylindrical part 622 arranged on an opening-side of the concave part 26. In the below, the inner side of the concave part 26 may be simply referred to as “inner side” and the opening-side of the concave part 26 may be simply referred to as “opening-side”.

In a central part of the columnar part 621, a columnar first flow path 623 through which the fluid flows, and a conical second flow path 624 formed on an opening-side of the first flow path 623 and having an outer diameter increasing from an inner side toward an opening-side are formed. The columnar part 621 is also formed with a groove 625 recessed from an outer peripheral surface over an entire circumference. In the groove 625, an 0-ring 626 for sealing between an outer peripheral surface of the valve seat 62 and an inner peripheral surface of the concave part 26 is fitted.

The cylindrical part 622 is formed with a plurality of circumferential through-holes 627 configured to communicate an inside and an outside. The through-holes 627 are each formed in a position where an inside of the cylindrical part 622 and the flow path 74 formed in the pump case 25 communicate with each other.

The valve body 61 is accommodated in the valve seat 62 and is in contact with an inner surface 628 configured to form the second flow path 624 of the valve seat 62, so that it can block the flow of oil from the flow path 72B toward the flow path 74. On the other hand, the valve body 61 is configured to form a gap between the valve body and the inner surface 628, thereby allowing the flow of oil from the flow path 72B toward the flow path 74. When flowing from the flow path 72B toward the flow path 74, the oil passes through the first flow path 623, the second flow path 624, the inside of the cylindrical part 622, and the through-holes 627. As described above, since the first flow path 623 has a columnar shape, the oil passing through the first flow path 623 flows from the inner side toward the opening-side in a column direction of the cylinder. In the below, the flow direction of oil passing through the first flow path 623 may also be referred to as ‘flow direction’.

The holding member 63 has a columnar first part 631 formed on an inner side and a columnar second part 632 formed on an opening-side and having an outer diameter smaller than an outer diameter of the first part 631. The second part 632 of the holding member 63 is arranged in the spring 64, and an end face of the first part 631 on an opening-side supports an end portion of the spring 64 on an inner side.

An outer diameter of the first part 631 is smaller than an inner diameter of the cylindrical part 622 of the valve seat 62, so that the first part 631 is accommodated in the cylindrical part 622. A surface of the first part 631 on an inner side is formed with a conical concave part 633, and the valve body 61 is held in the concave part 633. An outer peripheral portion of the first part 631 on an inner side is formed with a chamfered portion 634.

The cap 65 has a cylindrical part 651 formed on an inner side and a circular disc-shaped bottom part 652 formed on an opening-side.

An outer peripheral surface of the cap 65 is formed with a male screw 653 that is fitted with a female screw 251 formed on the pump case 25. A further opening-side of the outer peripheral surface of the cap 65 than the male screw 653 is formed with a groove 654 recessed from the outer peripheral surface over an entire circumference. In the groove 654, an O-ring 655 for sealing between the outer peripheral surface of the cap 65 and the inner peripheral surface of the concave part 26 is fitted.

An end portion of the cylindrical part 651 on an inner side is formed with a concave part 656 recessed from an inner peripheral surface. The concave part 656 has a cylindrical shape, and the cylindrical part 622 of the valve seat 62 is fitted in the concave part 656. A diameter of the inner peripheral surface of the cylindrical part 651 on a further opening-side than the concave part 656 is larger than a diameter of the outer peripheral surface of the cylindrical part 622 of the valve seat 62.

A surface of the bottom part 652 on an opening-side is formed with a linear groove 657.

In a state where the valve body 61 is arranged in the valve seat 62, the holding member 63 is arranged on the opening-side of the valve body 61 and the spring 64 is arranged around the second part 632 of the holding member 63, the cap 65 is fastened to the female screw 251 formed on the pump case 25. The cap 65 is configured to accommodate the holding member 63 and the spring 64, together with an inside of the valve seat 62. The O-ring 655 fitted in the cap 65 seals the concave part 26. A storage chamber S in which the oil is stored is formed by a space surrounded by a part of the holding member 63 on a further opening-side than the first part 631, the cap 65 and the cylindrical part 622 of the valve seat 62.

The cap 65 is configured to support an end portion of the spring 64 on the opening-side by a bottom surface 658 that is a surface of the bottom part 652 on an inner side. When the cap 65 is fastened to the pump case 25, a tool such as a flathead screwdriver inserted in the groove 657 rotates around a center line of the cap 65, so that a screwing depth of the cap 65 with respect to the pump case 25 changes. As the screwing depth of the cap 65 increases, a distance between the bottom surface 658 of the cap 65 and the first part 631 of the holding member 63 becomes shorter, and an initial load of the spring 64 increases. As the initial load of the spring 64 increases, a force with which the holding member 63 pushes the valve body 61 increases.

(Spring 64)

Subsequently, the spring 64 is described in detail.

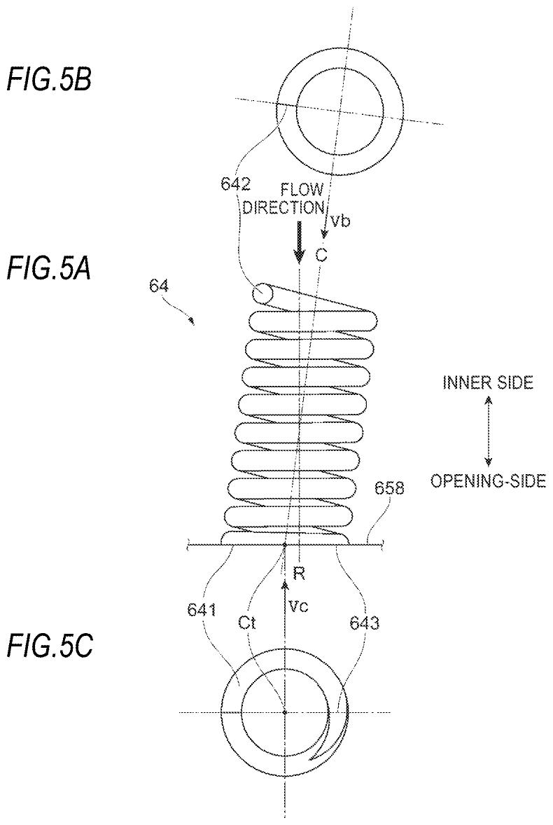

FIGS. 5A to 8C depict an example of the spring 64. FIG. 5A depicts the spring 64, as seen in a horizontal direction. FIG. 5B depicts the spring 64, as seen in a Vb direction of FIG. 5A. FIG. 5C depicts the spring 64, as seen in a Vc direction of FIG. 5A.

The spring 64 is a coil spring where a wire is wound in a coil shape. A direction of a center line C of the spring 64 is tilted with respect to the flow direction.

In the spring 64 of the first embodiment, an end portion on the bottom surface 658-side of the cap 65 is subjected to a grinding treatment so that a seat surface 641 tilted with respect to a surface perpendicular to the center line C is formed. The bottom surface 658 of the cap 65 configured to support an end portion of the spring 64 on an opening-side is a surface perpendicular to the flow direction. For this reason, the spring 64 is arranged so that the direction of the center line C is tilted with respect to the flow direction.

On the other hand, an end portion of the spring 64 on an inner side is not subjected to the grinding treatment. A winding end portion 642 of the wire on an inner side is located on the same side as a winding center Ct of the end portion on the opening-side with respect to a center line R of the first flow path 623 and the second flow path 624. In other words, the winding end portion 642 is located on an opposite side to a lowest end 643 in a slope direction of the center line C, with respect to the center line C, and is formed in a position deviating from the lowest end 643 by 160 to 200 degrees in a winding direction. The lowest end 643 is a portion at which the seat surface 641 of the end portion of the spring 64 on the opening-side begins to end.

(Operations)

In the below, operations of the down-blow valve 60 configured as described above are described in comparison with a case where a spring 100 of Comparative Example described below is used.

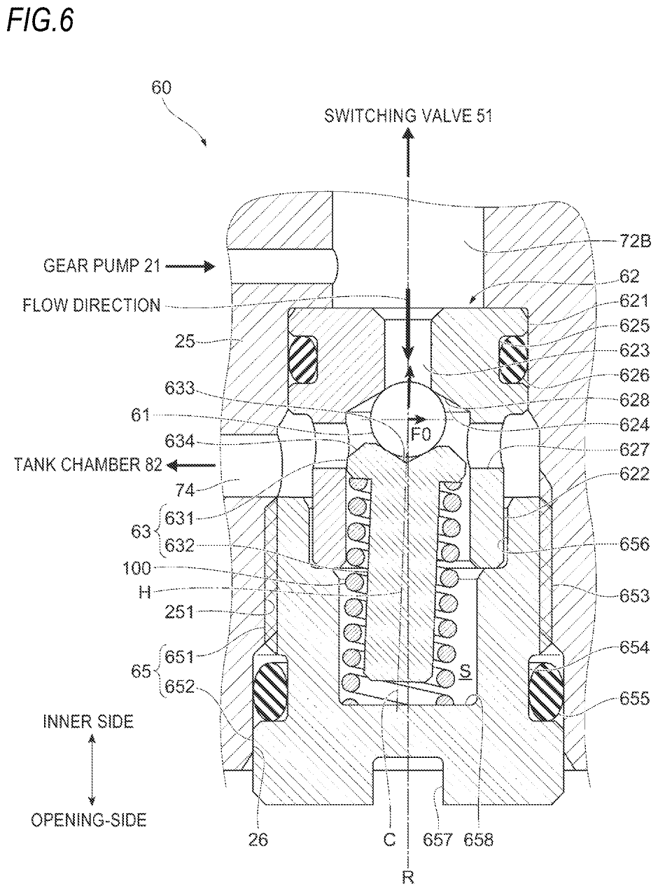

FIG. 6 depicts an example of a force that is applied to the valve body 61 when a spring 100 of Comparative Example is used.

The spring 100 of Comparative Example is different from the spring 64, in that an end portion on an inner side is subjected to the grinding treatment and a surface perpendicular to the center line C is formed. For the spring 100, since the first part 631 of the holding member 63 is applied with a spring force from the spring 100 evenly over the entire circumference, a direction of a center line H of the holding member 63 is the same as the direction of the center line C of the spring 100. For this reason, a center line of the conical concave part 633 formed in the first part 631 also extends in the direction of the center line C tilted with respect to the flow direction. As a result, the valve body 61 is applied with a force generated in the direction of the center line C. For this reason, the valve body 61 is applied with a force F0 in a direction orthogonal to the flow direction. In addition, if the end portion of the spring 64 on the inner side is formed with a surface perpendicular to the center line C, the second part 632 of the holding member 63 extents in the direction of the center line C tilted with respect to the flow direction.

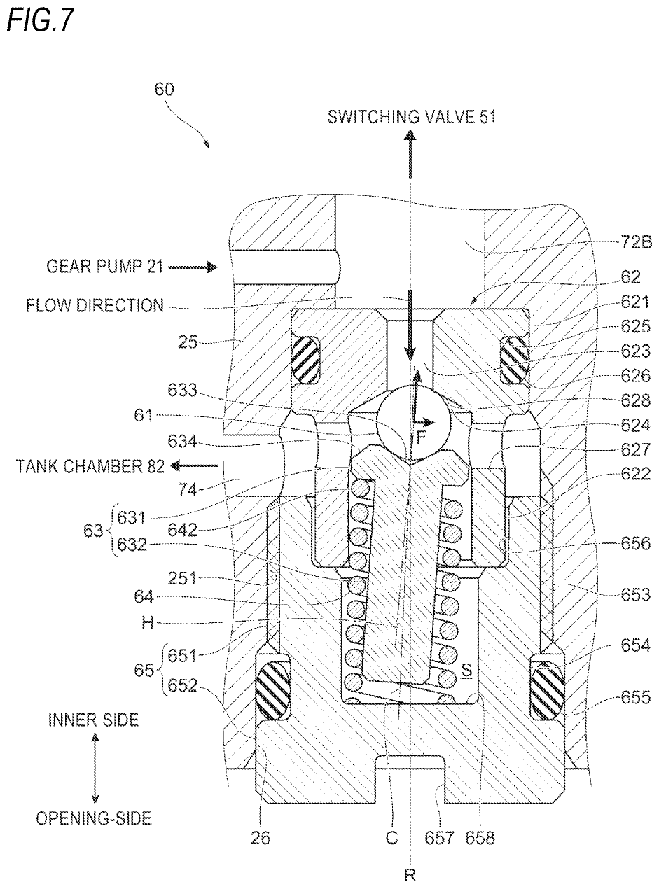

FIG. 7 depicts an example of a force that is applied to the valve body 61 when the spring 64 of the first embodiment is used.

For the spring 64 of the first embodiment, the end portion on the inner side is not subjected to the grinding treatment, the winding end portion 642 on the inner side is located on an opposite side to the lowest end 643 in the slope direction of the center line C, with respect to the center line C, and is formed in the position deviating from the lowest end 643 by 160 to 200 degrees in the winding direction. For this reason, the first part 631 of the holding member 63 is applied with a higher force at a portion in contact with the winding end portion 642 than other circumferential portion. For this reason, the direction of the center line H of the holding member 63 is tilted with respect to the direction of the center line C of the spring 64, so that an angle between the center line H of the holding member 63 and the center line R of the first flow path 623 becomes greater than an angle shown in FIG. 6, as shown in FIG. 7. As a result, a direction of the force generated for the valve body 61 is tilted with respect to the direction of the center line C, so that an angle between the direction of the force generated for the valve body 61 and the center line R of the first flow path 623 becomes greater than an angle shown in FIG. 6, as shown in FIG. 7. For this reason, a force F in a direction orthogonal to the flow direction, which is applied to the valve body 61, becomes higher than the force F0 when the spring 100 of Comparative Example is used.

In addition, since the direction of the center line H of the holding member 63 is tilted with respect to the direction of the center line C of the spring 64, as shown in FIG. 7, the end portion of the second part 632 on the opening-side is more likely to contact the inner portion of the spring 64, as compared to the case where the spring 100 of Comparative Example is used.

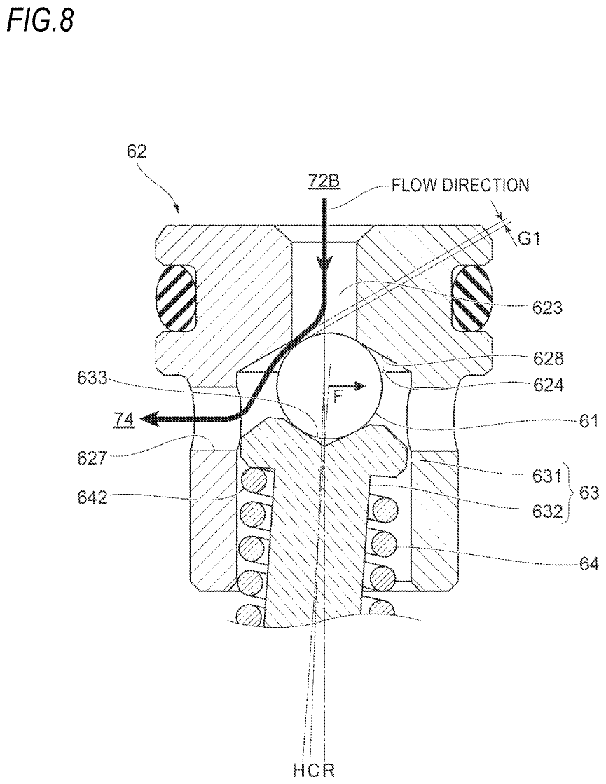

FIG. 8 depicts an example of a state where oil flows through a gap between the valve body 61 and the inner surface 628 of the valve seat 62.

The down-blow valve 60 configured as described above is an example of the valve device having the valve seat 62, the valve body 61, the holding member 63 and the spring 64. The valve seat 62 is an example of the flow path forming member having the first flow path 623 through which the oil flows, and the conical second flow path 624 formed on a downstream side of the first flow path 623 and having an outer diameter increasing in the flow direction of the first flow path 623. The valve body 61 is a spherical object that can block the flow of oil in the first flow path 623 by contacting the inner surface 628 of the valve seat 62 forming the second flow path 624. The holding member 63 is configured to hold the valve body 61 in the conical concave part 633. The spring 64 is arranged so that it applies a force in a direction of causing the valve body 61 to contact the inner surface 628 via the holding member 63 and the direction of the center line C of the coil having a coil shape is tilted with respect to the flow direction.

According to the down-blow valve 60 configured as described above, the valve body 61 is applied with the force F in the direction orthogonal to the flow direction. For this reason, when the pressure in the flow path 72B becomes equal to or higher than the predetermined pressure, the valve body 61 once separates from the inner surface 628 of the valve seat 62 and then the pressure in the flow path 72B becomes lower than the predetermined pressure, the valve body 61 is moved in the direction in which the force F is applied. Then, as shown in FIG. 8, even when the center of the valve body 61 deviates from the center line R of the second flow path 624 and the valve body 61 contacts the inner surface 628 of the valve seat 62, a gap G1 is formed between the valve body 61 and the inner surface 628 without completely blocking the opening of the first flow path 623. As a result, when the pressure in the flow path 72B is a positive pressure, the oil flows from the flow path 72B toward the flow path 74 through the gap G1 between the valve body 61 and the inner surface 628. For this reason, even when the pressure in the flow path 72B varies, the valve body 61 and the holding member 63 are suppressed from vibrating according to the variation. As a result, a mechanical sound and a whistle sound at a time when the oil flows through the slight gap are suppressed.

In the down-blow valve 60, as shown in FIG. 5A, the end portion of the spring 64 on an opposite side to a side on which the spring is in contact with the holding member 63 is subjected to the grinding treatment and is thus formed with the seat surface 641 tilted with respect to the surface perpendicular to the direction of the center line C. Thereby, the spring 64 is arranged so that the direction of the center line C is tilted with respect to the flow direction.

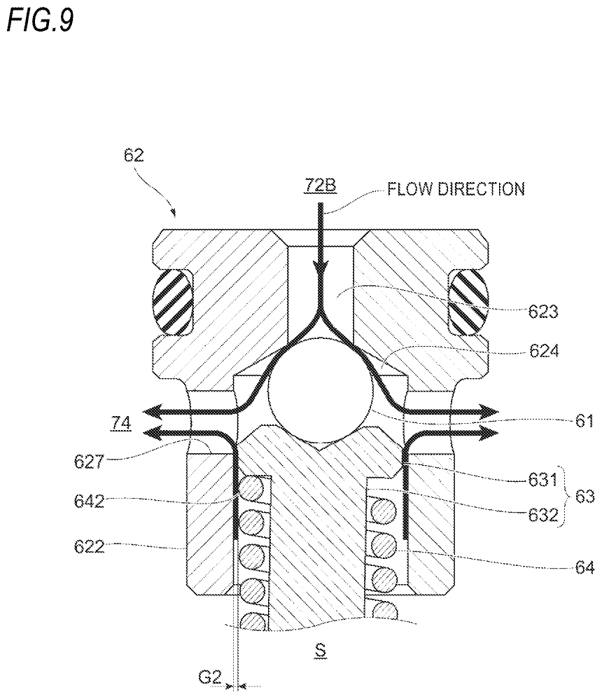

FIG. 9 depicts an example of a state where a damping force is generated. In the down-blow valve 60, the oil flows from a gap G2 between the outer peripheral surface of the first part 631 of the holding member 63 and the inner peripheral surface of the cylindrical part 622 of the valve seat 62 into the storage chamber S. When the valve body 61 is applied with the high pressure from the flow path 72B and the holding member 63 is thus moved toward the opening-side, the oil in the storage chamber S flows out from the gap G2 between the outer peripheral surface of the first part 631 of the holding member 63 and the inner peripheral surface of the cylindrical part 622 of the valve seat 62 to an outside of the storage chamber S.

That is, in the down-blow valve 60, the valve seat 62 has the cylindrical part 622 formed downstream of the second flow path 624 and having a cylindrical shape and the through-holes 627. The down-blow valve 60 further includes the cap 65 as an example of the cover member configured to cover the opening of the cylindrical part 622 of the valve seat 62 and to accommodate the holding member 63 and the spring 64, together with the cylindrical part 622. When the holding member 63 is moved against the force of the spring 64, the oil flowing into the further opening-side than the first part 631 in the cylindrical part 622 and the cap 65 flows out only from the gap G2 between the outer peripheral surface of the first part 631 and the inner peripheral surface of the cylindrical part 622. Thereby, the damping force is generated, so that the valve body 61 and the holding member 63 are suppressed from vibrating. As a result, generation of the mechanical sound is suppressed.

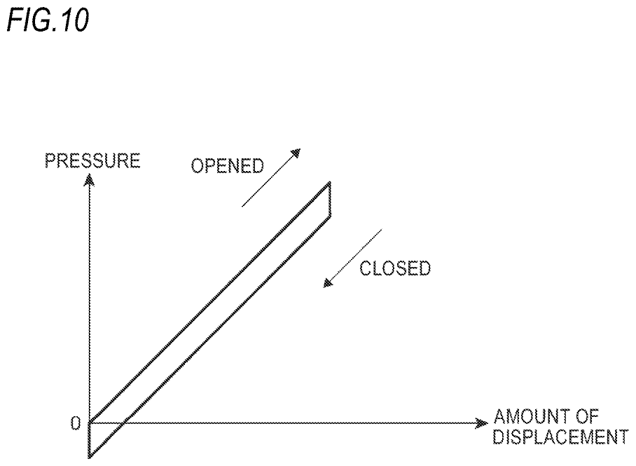

FIG. 10 depicts a relation between a pressure generated for the valve body 61 and an amount of displacement of the valve body 61.

The direction of the center line H of the holding member 63 is tilted with respect to the direction of the center line C of the spring 64. For this reason, in particular, the spring 64 contracts to reduce a distance between the wires adjacent to each other in the direction of the center line C or the spring 64 is bent, so that the end portion of the second part 632 of the holding member 63 on the opening-side is contacted to the spring 64. For this reason, even when a friction force is generated between the holding member 63 and the spring 64 and the pressure generated for the valve body 61 is lowered, the holding member 63 is difficult to return. As a result, as shown in FIG. 10, a relation between the pressure generated for the valve body 61 and the amount of displacement of the valve body 61 when the pressure on the flow path 72B-side generated for the valve body 61 is increased and the valve body 61 is thus opened and a relation between the pressure generated for the valve body 61 and the amount of displacement of the valve body 61 when the pressure generated for the valve body 61 is lowered and the valve body 61 is thus closed are different from each other. For this reason, after the pressure in the flow path 72B is increased and thus the valve body 61 once separates from the inner surface 628 of the valve seat 62, even when the pressure in the flow path 72B is lowered, the valve body 61 is difficult to contact the inner surface 628 of the valve seat 62. As a result, generation of the mechanical sound is suppressed. In addition, even when the pressure in the flow path 72B is the same, the gap between the valve body 61 and the inner surface 628 of the valve seat 62 increases due to the spring 64, as compared to the case where the spring 100 of Comparative Example is used. As a result, a whistle sound at a time when the oil flows through the slight gap is suppressed.

### Second Embodiment

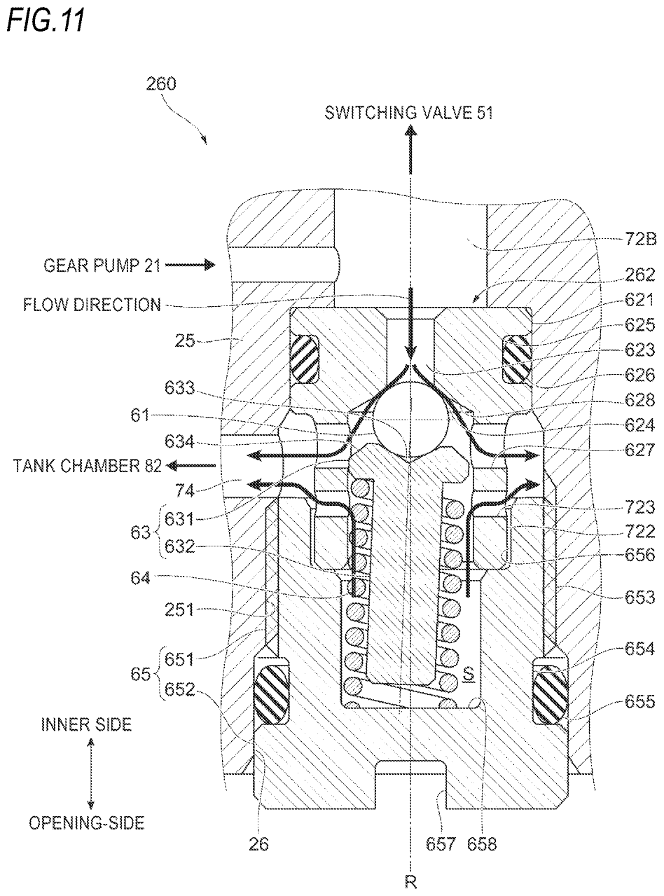

FIG. 11 depicts an example of a schematic configuration of a down-blow valve 260 in accordance with a second embodiment.

The down-blow valve 260 is different from the down-blow valve 60 of the first embodiment, in terms of a valve seat 262 corresponding to the valve seat 62. In the below, differences from the down-blow valve 60 are described. The parts having the same functions between the down-blow valve 60 and the down-blow valve 260 are denoted with the same reference signs, and the detailed descriptions thereof are omitted.

The valve seat 262 has a columnar part 621, and a cylindrical part 722 arranged on a further opening-side than the columnar part 621. The cylindrical part 722 is formed with communication holes 723 configured to communicate an inside and an outside on a further opening-side than the through-holes 627, in addition to the through-holes 627. The communication holes 723 are formed on a further opening-side than the first part 631 of the holding member 63. The communication holes 723 are also formed in plural (for example, four) in the circumferential direction.

In the down-blow valve 260 configured as described above, when the valve body 61 is applied with a high pressure from the flow path 72B-side and the holding member 63 is thus moved to the opening-side, the oil in the storage chamber S is discharged to an outside of the storage chamber S through the communication holes 723 formed in the cylindrical part 722 of the valve seat 262. Thereby, the damping force upon movement of the holding member 63 toward the opening-side is lower than the damping force in the down-blow valve 60 of the first embodiment. However, in the down-blow valve 260, like the down-blow valve 60, even when the pressure in the flow path 72B varies, the valve body 61 and the holding member 63 are suppressed from vibrating according to the variation. As a result, a mechanical sound and a whistle sound at a time when the oil flows through the slight gap are suppressed.

### Third Embodiment

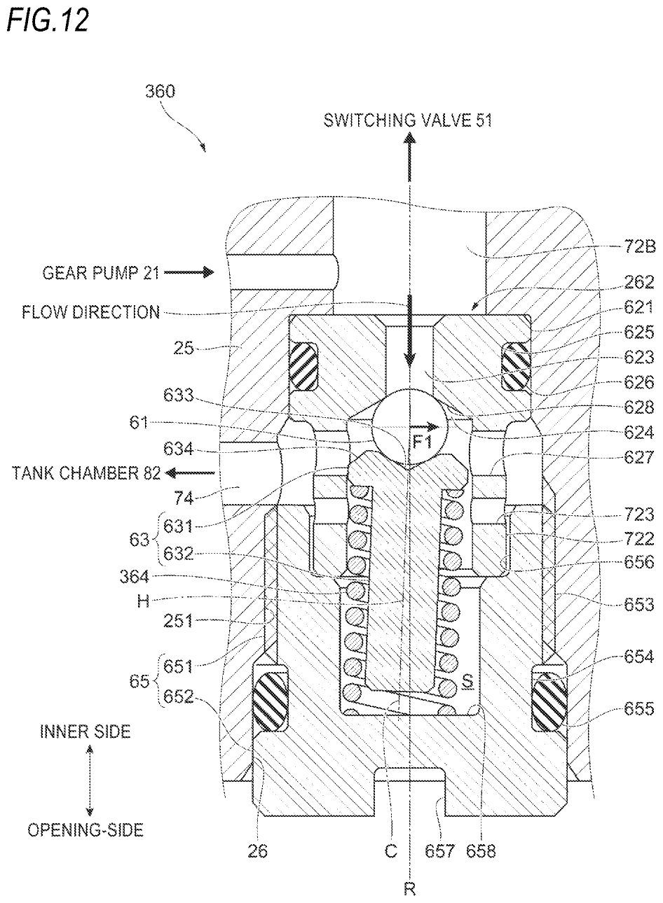

FIG. 12 depicts an example of a schematic configuration of a down-blow valve 360 in accordance with a third embodiment.

The down-blow valve 360 is different from the down-blow valve 260 of the second embodiment, in terms of a spring 364 corresponding to the spring 64. In the below, differences from the down-blow valve 260 are described. The parts having the same functions between the down-blow valve 260 and the down-blow valve 360 are denoted with the same reference signs, and the detailed descriptions thereof are omitted.

The spring 364 is different from the spring 64, in that an end portion on an inner side is subjected to a grinding treatment and is thus formed with a surface perpendicular to the direction of the center line C. Thereby, since the first part 631 of the holding member 63 is applied with a spring force from the spring 364 evenly over the entire circumference, the direction of the center line H of the holding member 63 is the same as the direction of the center line C of the spring 364.

Also in the down-blow valve 360 configured as described above, since the spring 364 is formed with the seat surface 641 tilted with respect to the surface perpendicular to the center line C, the spring 364 is arranged so that the direction of the center line C is tilted with respect to the flow direction. For this reason, the valve body 61 is applied with a force Fl in the direction orthogonal to the flow direction. As a result, when the pressure in the flow path 72B becomes equal to or higher than the predetermined pressure, the valve body 61 once separates from the inner surface 628 of the valve seat 262 and then the pressure in the flow path 72B becomes lower than the predetermined pressure, the valve body 61 is moved in the direction in which the force Fl is applied. Then, even when the valve body 61 contacts the inner surface 628 of the valve seat 262, a gap is formed between the valve body 61 and the inner surface 628 without completely blocking the opening of the first flow path 623, so that the oil flows from the flow path 72B toward the flow path 74 through the gap between the valve body 61 and the inner surface 628. As a result, even when the pressure in the flow path 72B varies, the valve body 61 and the holding member 63 are suppressed from vibrating according to the variation, and a mechanical sound and a whistle sound at a time when the oil flows through the slight gap are suppressed.

Note that, the spring 364 of the third embodiment can also be applied to the down-blow valve 60 of the first embodiment.

### Fourth Embodiment

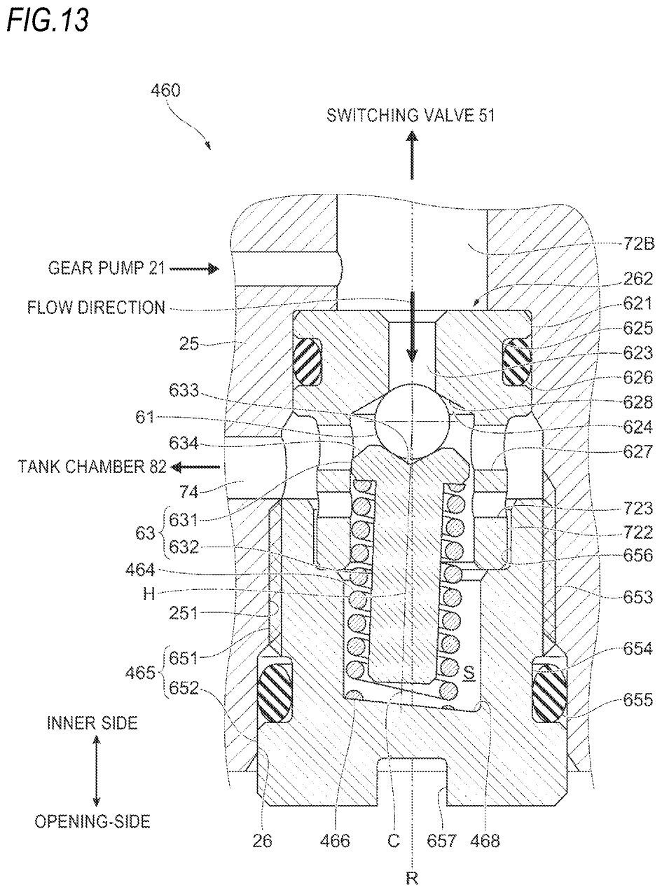

FIG. 13 depicts an example of a schematic configuration of a down-blow valve 460 in accordance with a fourth embodiment.

The down-blow valve 460 is different from the down-blow valve 360 of the third embodiment, in terms of a spring 464 corresponding to the spring 364 and a cap 465 corresponding to the cap 65. In the below, differences from the down-blow valve 360 are described. The parts having the same functions between the down-blow valve 360 and the down-blow valve 460 are denoted with the same reference signs, and the detailed descriptions thereof are omitted.

The spring 464 is different from the spring 64, in that an end portion on an opening-side is subjected to a grinding treatment and is thus formed with a seat surface 466 perpendicular to the direction of the center line C. That is, both an end portion on an inner side and an end portion on an opening-side of the spring 464 are formed with the surfaces perpendicular to the direction of the center line C.

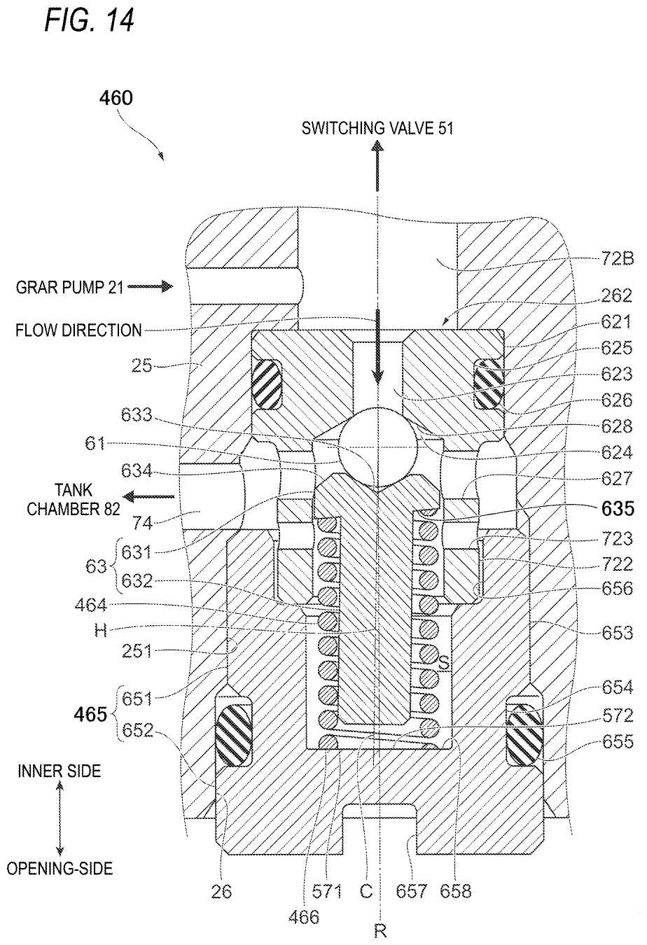

The cap 465 is different from the cap 65, in that a bottom surface 468, which is a surface of the bottom part 652 on an inner side, is tilted with respect to the surface perpendicular to the flow direction. That is, the bottom surface 468 as an example of the surface configured to support an end portion of the spring 464 on an opposite side to a side on which the spring is in contact with the holding member 63 is tilted with respect to the surface perpendicular to the flow direction. Note that, as shown in FIG. 14, a surface 635 of the first part 631 of the holding member 63 in contact with the end portion of the spring 464, not the bottom surface 468 of the bottom part 652 of the cap 465, may be tilted with respect to the surface perpendicular to the flow direction.

Also in the down-blow va1ve460 configured as described above, the spring 464 is arranged so that the direction of the center line C is tilted with respect to the flow direction. In other words, the coil spring whose both end portions are subjected to the grinding treatment and are thus formed with the surfaces perpendicular to the direction of the center line C is used as the spring 464 and the bottom surface 468 of the cap 65 is tilted with respect to the surfaces perpendicular to the flow direction, so that the spring 464 is arranged so that the direction of the center line C is tilted with respect to the flow direction. For this reason, even when the valve body 61 is contacted to the inner surface 628 of the valve seat 262, a gap is likely to be formed between the valve body 61 and the inner surface 628, so that the oil can easily flow from the flow path 72B toward the flow path 74 through the gap between the valve body 61 and the inner surface 628. As a result, even when the pressure in the flow path 72B varies, the valve body 61 and the holding member 63 are suppressed from vibrating according to the variation, and a mechanical sound and a whistle sound at a time when the oil flows through the slight gap are suppressed.

Note that, the features of the down-blow valve 460 of the fourth embodiment can also be applied to the down-blow valve 60 of the first embodiment. That is, the end portion of the spring 64 on the opening-side of the first embodiment may be formed with the seat surface 466 perpendicular to the direction of the center line C, and the cap 465 may be used instead of the cap 65.

In addition, the features of the down-blow valve 460 of the fourth embodiment can be applied to the down-blow valve 260 of the second embodiment.

### Fifth Embodiment

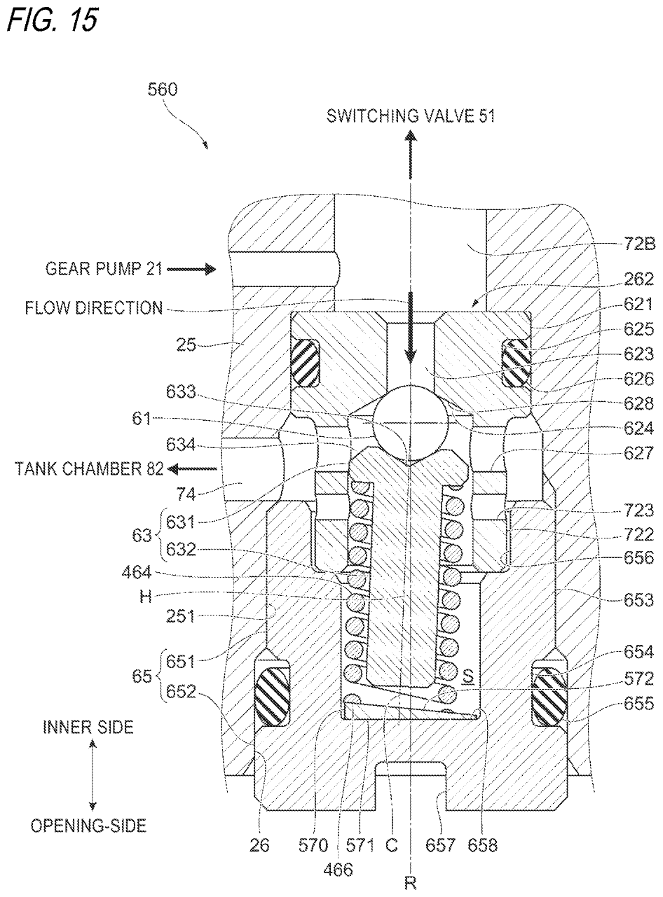

FIG. 15 depicts an example of a schematic configuration of a down-blow valve 560 in accordance with a fifth embodiment.

The down-blow valve 560 is different from the down-blow valve 360 of the third embodiment, in that the spring 464 of the fourth embodiment is provided instead of the spring 364 and an interposition member 570 is interposed between the spring 464 and the bottom surface 658 of the cap 65. In the below, differences from the down-blow valve 360 are described. The parts having the same functions between the down-blow valve 360 and the down-blow valve 560 are denoted with the same reference signs, and the detailed descriptions thereof are omitted.

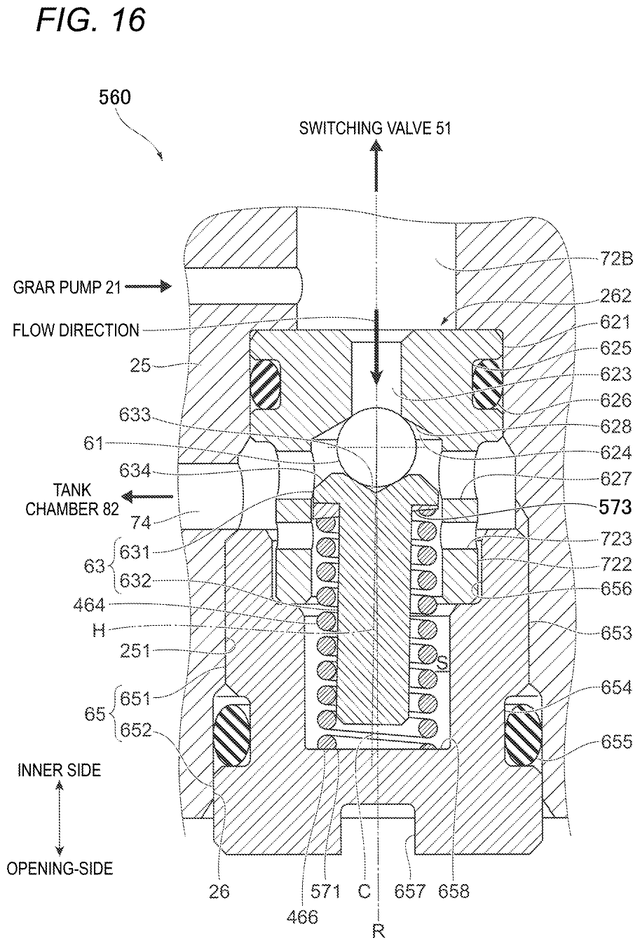

The interposition member 570 is a circular disc-shaped or annular ring-shaped member. A surface 572 on an inner side is tilted with respect to a surface 571 of the interposition member 570 on an opening-side. In other words, the interposition member 570 is interposed between the spring 464 whose both end portions are subjected to the grinding treatment and are thus formed with surfaces perpendicular to the direction of the center line C and the bottom surface 658 of the cap 65, so that the spring 464 is arranged so that the direction of the center line C is tilted with respect to the flow direction. Note that, as shown in FIG. 16, an annular ring-shaped interposition member 573 may be interposed between a surface of the first part 631 of the holding member 63 on a side in contact with an end portion of the spring 464 and the spring 464, not between the spring 464 and the bottom surface 658 of the cap 65, so that the spring 464 may be arranged so that the direction of the center line C is tilted with respect to the flow direction.

As described above, the down-blow valve 560 has the interposition member 570 interposed between the bottom part 652 of the cap 65 as an example of the support part configured to support an end portion of the spring 464 on an opposite side to a side in contact with the holding member 63, and the end portion on the opposite side. The interposition member 570 has a circular disc shape, and the surface 572 on the end portion-side on the opposite side is tilted with respect to the surface 571 on the bottom part 652-side of the cap 65.

Also in the down-blow valve 560 configured as described above, even when the valve body 61 is contacted to the inner surface 628 of the valve seat 262, a gap is likely to be formed between the valve body 61 and the inner surface 628, so that the oil can easily flow from the flow path 72B toward the flow path 74 through the gap between the valve body 61 and the inner surface 628. As a result, even when the pressure in the flow path 72B varies, the valve body 61 and the holding member 63 are suppressed from vibrating according to the variation, and a mechanical sound and a whistle sound at a time when the oil flows through the slight gap are suppressed.

Note that, the features of the down-blow valve 560 of the fifth embodiment can also be applied to the down-blow valve 60 of the first embodiment. That is, the end portion of the spring 64 on the opening-side of the first embodiment may be formed with the seat surface 466 perpendicular to the direction of the center line C, and the interposition member 570 may be interposed between the spring 64 and the cap 65.

In addition, the features of the down-blow valve 560 of the fifth embodiment can be applied to the down-blow valve 260 of the second embodiment.

Note that, the up-blow valve 53 may also be configured to have a similar configuration to the down-blow valve 60 of the first embodiment, the down-blow valve 260 of the second embodiment, the down-blow valve 360 of the third embodiment, the down-blow valve 460 of the fourth embodiment or the down-blow valve 560 of the fifth embodiment.

According to the present invention, it is possible to provide the valve device and the like capable of suppressing generation of a sound.

What is claimed is:

1. A valve device comprising:
a flow path forming member having a first flow path through which a fluid is to flow, and a conical second flow path formed on a downstream side of the first flow path and having an outer diameter increasing in a flow direction of the first flow path;
a spherical valve body capable of blocking a flow of the fluid in the first flow path by contacting an inner surface of the flow path forming member, which forms the second flow path;
a holding member configured to hold the valve body in a conical concave part; and
a coil-shaped spring configured to apply a force in a direction of causing the valve body to contact the inner surface via the holding member and arranged so that a direction of a center line of the coil is tilted with respect to the flow direction.

2. The valve device according to claim 1, wherein an end portion of the spring on an opposite side to a side on which the spring is in contact with the holding member is subjected to a grinding treatment and is thus formed with a seat surface tilted with respect to a surface perpendicular to the direction of the center line.

3. The valve device according to claim 1, wherein a surface configured to support an end portion of the spring on an opposite side to a side on which the spring is in contact with the holding member is tilted with respect to a surface perpendicular to the flow direction.

4. The valve device according to claim 1, wherein a surface of the holding member configured to support an end portion of the spring is tilted with respect to a surface perpendicular to the flow direction.

5. The valve device according to claim 1, further comprising an interposition member interposed between a support part configured to support an end portion of the spring on an opposite side to a side on which the spring is in contact with the holding member and the end portion on the opposite side,
wherein a surface of the interposition member on the end portion-side on the opposite side is tilted with respect to a surface of the interposition member on the support part-side.

6. The valve device according to claim 1, further comprising an interposition member interposed between an end portion of the spring on a side on which the spring is in contact with the holding member and the holding member,
wherein a surface of the interposition member on the end portion-side on the side on which the spring is in contact with the holding member is tilted with respect to a surface of the interposition member on the holding member-side.

7. The valve device according to claim 1, wherein a winding end portion of the spring on a side on which the spring is in contact with the holding member is located on an opposite side to a lowest end of the spring in a slope direction of the center line, with respect to the center line.

8. The valve device according to claim 1, wherein
the holding member has a columnar first part having the concave part formed therein, and a columnar second part having an outer diameter smaller than an outer diameter of the first part,
the spring is arranged around the second part and an end portion of the spring in a direction of the center line is in contact with the first part and
when the spring contracts, a tip end portion of the second part is brought into contact with the spring.

9. The valve device according to claim 1, wherein
the flow path forming member has a cylindrical part formed on a downstream side of the second flow path and having a through-hole,
the holding member has a columnar first part having the concave part formed therein, and a columnar second part having an outer diameter smaller than an outer diameter of the first part,
the valve device further comprises a cover member configured to cover an opening of the cylindrical part and configured to accommodate the holding member and the spring together with the cylindrical part, and
when the holding member is moved against a force of the spring, the fluid flowing into the further opening-side than the first part in the cylindrical part and the cap flows out only from a gap between an outer peripheral surface of the first part and an inner peripheral surface of the cylindrical part.

10. A pump device comprising:
a pump configured to supply a fluid;
a tank configured to store the fluid;
a switching valve configured to switch a flow direction of the fluid supplied from the pump; and
the valve device according to claim 1 connected to an intermediate flow path between the pump and the switching valve and configured to be opened to return the fluid in the intermediate flow path to the tank when a pressure in the intermediate flow path becomes equal to or higher than a predetermined pressure.

11. A trim tilt device comprising:
a cylinder device configured to expand and contract due to supply and discharge of a fluid, and
the pump device according to claim 10 configured to supply the fluid to the cylinder device.

12. The valve device according to claim 2, wherein a winding end portion of the spring on a side on which the spring is in contact with the holding member is located on an opposite side to a lowest end of the spring in a slope direction of the center line, with respect to the center line.

13. The valve device according to claim 2, wherein
the holding member has a columnar first part having the concave part formed therein, and a columnar second part having an outer diameter smaller than an outer diameter of the first part,
the spring is arranged around the second part and an end portion of the spring in a direction of the center line is in contact with the first part and
when the spring contracts, a tip end portion of the second part is brought into contact with the spring.

14. The valve device according to claim 2, wherein
the flow path forming member has a cylindrical part formed on a downstream side of the second flow path and having a through-hole,
the holding member has a columnar first part having the concave part formed therein, and a columnar second part having an outer diameter smaller than an outer diameter of the first part,
the valve device further comprises a cover member configured to cover an opening of the cylindrical part and configured to accommodate the holding member and the spring together with the cylindrical part, and
when the holding member is moved against a force of the spring, the fluid flowing into the further opening-side than the first part in the cylindrical part and the cap flows out only from a gap between an outer peripheral surface of the first part and an inner peripheral surface of the cylindrical part.

15. A pump device comprising:
a pump configured to supply a fluid;
a tank configured to store the fluid;
a switching valve configured to switch a flow direction of the fluid supplied from the pump; and
the valve device according to claim 2 connected to an intermediate flow path between the pump and the switching valve and configured to be opened to return the fluid in the intermediate flow path to the tank when a pressure in the intermediate flow path becomes equal to or higher than a predetermined pressure.

16. A trim tilt device comprising:
a cylinder device configured to expand and contract due to supply and discharge of a fluid, and
the pump device according to claim 15 configured to supply the fluid to the cylinder device.

17. The valve device according to claim 3, wherein a winding end portion of the spring on a side on which the spring is in contact with the holding member is located on an opposite side to a lowest end of the spring in a slope direction of the center line, with respect to the center line.

18. The valve device according to claim 3, wherein
the holding member has a columnar first part having the concave part formed therein, and a columnar second part having an outer diameter smaller than an outer diameter of the first part,
the spring is arranged around the second part and an end portion of the spring in a direction of the center line is in contact with the first part and
when the spring contracts, a tip end portion of the second part is brought into contact with the spring.

19. The valve device according to claim 3, wherein
the flow path forming member has a cylindrical part formed on a downstream side of the second flow path and having a through-hole,
the holding member has a columnar first part having the concave part formed therein, and a columnar second part having an outer diameter smaller than an outer diameter of the first part,
the valve device further comprises a cover member configured to cover an opening of the cylindrical part and configured to accommodate the holding member and the spring together with the cylindrical part, and
when the holding member is moved against a force of the spring, the fluid flowing into the further opening-side than the first part in the cylindrical part and the cap flows out only from a gap between an outer peripheral surface of the first part and an inner peripheral surface of the cylindrical part.

20. A pump device comprising:
a pump configured to supply a fluid;
a tank configured to store the fluid;
a switching valve configured to switch a flow direction of the fluid supplied from the pump; and
the valve device according to claim 3 connected to an intermediate flow path between the pump and the switching valve and configured to be opened to return the fluid in the intermediate flow path to the tank when a pressure in the intermediate flow path becomes equal to or higher than a predetermined pressure.
